(19) United States
(12) Patent Application Publication
(10) Pub. No.: US 2013/0054706 A1
(43) Pub. Date: Feb. 28, 2013

(54) Modulation of Visual Notification Parameters Based on Message Activity and Notification Value

(71) Applicants: Mary Graham, San Francisco, CA (US); Aaron Sittig, San Francisco, CA (US); Erick Tseng, San Francisco, CA (US)

(72) Inventors: Mary Graham, San Francisco, CA (US); Aaron Sittig, San Francisco, CA (US); Erick Tseng, San Francisco, CA (US)

(21) Appl. No.: 13/220,412

(22) Filed: Aug. 29, 2011

(51) Int. Cl. G06F 15/16

(52) U.S. Cl. 709/206

(57) ABSTRACT

A communications device that modulates one or more operating parameters of a visual message indicator to reflect one or more aspects of messaging activity directed or relating to a user.

### TECHNICAL FIELD

The present disclosure relates generally to communication devices and visual notifications and, more particularly, to communications devices that modulate one or more operating parameters of a visual notification based on message activity and value.

### BACKGROUND

Communication devices, such as smartphones and tablets, may host a variety of messaging applications, such as voice messaging, short text messaging, instant messaging, electronic mail, RSS clients, blogging, micro-blogging, and the like. Communications devices often feature an indicator, such as a small Light-Emitting Diode (LED), that indicates the status of the device, such as low power or connectivity, the presence of messages and the like.

### SUMMARY

Particular embodiments of the invention are directed to a communications device that modulates one or more operating parameters of a visual message indicator to reflect one or more aspects of messaging activity directed or relating to a user. These and other features, aspects, and advantages of the disclosure are described in more detail below in the detailed description and in conjunction with the following figures.

### DESCRIPTION OF THE DRAWINGS

FIG. 1 illustrates an example social networking system.

FIG. 2 illustrates an example smartphone interface including an indicator light.

FIG. 3 illustrates an example computer system.

FIG. 4 illustrates an example mobile device platform.

FIGS. 5A and 5B illustrate example processes for adjusting operating parameters of a notification light based on messaging activity.

FIG. 6 is a block diagram of an affinity function for computing a measure of affinity for users of a social networking system, in accordance with an embodiment of the invention.

FIG. 7 is a block diagram of a social networking system, in accordance with an embodiment of the invention.

FIG. 8 is a flow chart of a method for computing a measure of affinity for a user of a social networking system, in accordance with an embodiment of the invention.

### DESCRIPTION OF EXAMPLE EMBODIMENT(S)

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Message indicators, such as LEDs, are useful for mobile communications devices in that they may notify a user of incoming messages without the user having to constantly access the device, causing depletion of battery resources. Implementations of the invention are directed to modulating one or more operating parameters of a message indicator based on messaging activity. In one implementation, the modulation scheme for one or more of the operating parameters is configured to communicate to the user a general sense of the messaging activity directed, and/or related, to the user. Implementations of the invention, for example, may be configured to convey the level of messaging activity to the user, the immediate relevancy of messaging activity to the user's current context, the connection between the user and the sources of the message activity and the like.

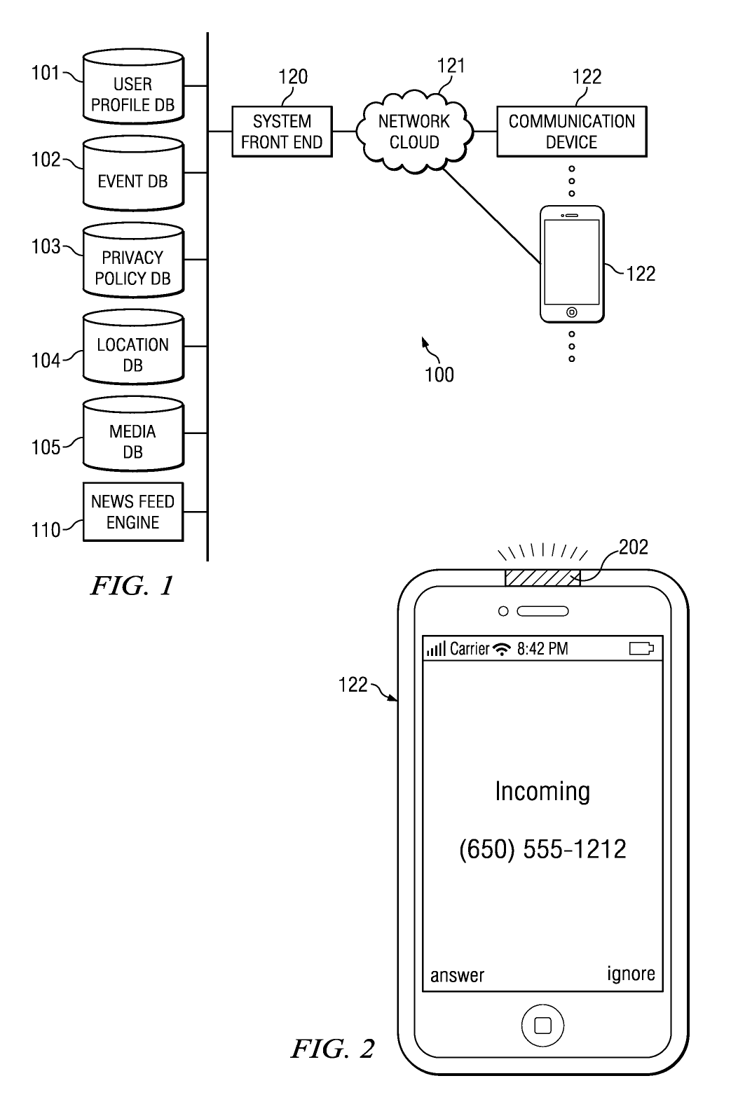

FIG. 1 illustrates an example social networking system 100 and environment in which various implementations of the invention may operate. Users may access the social networking system and other remote hosts over a network 121 using a communications device 122. For example, users may access the social networking system and other remote hosts to post and access content. Other remote hosts may implement other network applications, such as web sites, electronic mail services, and the like.

Communications device 122 may support a variety of different communications channels and message types. For example, communications device 122, connected through a wireless network, may interact with other client devices through the circuit-switched, or non-data, portion of a wireless network. For example, a user at communications device 122 may transmit and receive a non-VoIP call to a cellular phone or landline, transmit and receive a text or multi-media message through the SMS or MMS channels, or receive push notifications through an SMS control channel. Communications device 122 may interact with external websites and other service providers through a web browser residing on the client device, or a dedicated application local to communications device 122. For example, communications device 122 may interact with an instant VoIP service, such as Google Voice™ or Skype™, by visiting and logging into their account via a web browser, or by installing and running a dedicated application. A user of communications device 122 interacts with social networking system 100 via an application, such as a web browser or a native application, to perform operations such as browsing content, posting and sending messages, retrieving and sorting messages received from other users, and the like. Communications device 122 has one or more memories capable of storing call, text, and other messaging data.

Messages can be in any electronic message format such as electronic mail (“e-mail”) messages, instant messages (IMs), chat messages, activity stream or news feed objects, and short message service (SMS) text messages. Messages can contain plain text, or they can contain other content such as pictures, videos, and attachments. In some implementations, each user has a message inbox that includes messages that are both sent and received by the user. Communications device 122 may also use an application or browser to pull and view profile information for various user nodes and hubs in social networking system 100. Communications device 122, as discussed above, may host one or more applications that are operative to receive (either through push and/or pull methods) messages and process them for display to a user.

Messages typically include one or more of a sender identifier, a destination identifier and/or device address, a subject, a time sent, a time received, and message content (such as text and/or multimedia). As discussed herein, messages may be transmitted between users directly over a messaging service or through an application service, such as social networking system 100. For example, a user may access the social networking system 100 to compose and send a message. Alternatively, the user may send an SMS over a wireless communication service more directly to a user. In yet other implementations, a user may post a status update or upload content to the social networking system 100, causing a newsfeed object to be transmitted to one or more other users.

FIG. 2 illustrates, for didactic purposes, an example communications device 122. The communications device 122 depicted in FIG. 2 is a portable smartphone that includes a message indicator 202. In one implementation, message indicator 202 comprises a light-emitting diode (LED) and in some implementations a transparent or translucent member or housing that encases or protects the LED. The messaging indicator 202, in some implementations, may be part of a physical button mounted on the housing of the communications device. According to implementations of the invention, communications device 122 hosts a messaging monitoring application that monitors messaging activity associated with the communications device and modulates one or more operating parameters based on the messaging activity, as discussed in more detail below. The messaging monitoring application may be implemented as a stand-alone or separate process that monitors messages consumed by a plurality of different applications hosted on the communications device (e.g., email client, SMS client, IM client, a RSS or news feed client, etc.). In other implementations, the messaging monitoring application may be integrated into and operate in connection with only a single application, such as an email client or a native social network application, which itself can handle a variety of message types. As such, the messaging monitoring application can register as a listener for incoming messages of a variety of different types and process them as described herein.

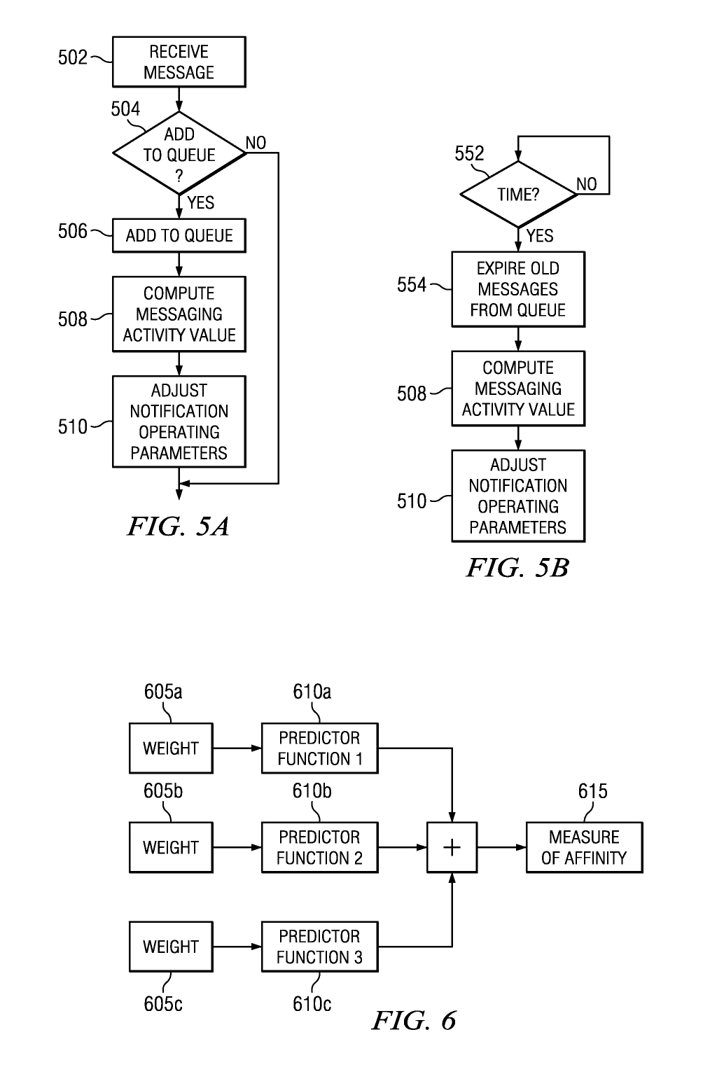

FIGS. 5A and 5B illustrate example processes that may be implemented by the messaging activity monitoring application. In some implementations, the message activity monitoring application is initiated after a period of inactivity, such as when the communications device 122 enters an idle state and the display screen powers down. The messaging indicator can operate to give the user a sense of the messaging activity monitored by the mobile device without the user having to access the device and power up the display. When the user accesses or activates the device, the messaging indicator may enter another operating mode. In other implementations, the message activity monitoring application runs constantly as a background process. In other implementations, the messaging activity monitoring application may be initiated in response to an explicit user command.

In one implementation, the message activity monitoring application maintains a messaging activity queue of received messages and adjusts one or more operational parameters of a message indicator based on the contents of the messaging activity queue. In one implementation, the messaging activity queue may be implemented as a circular buffer or ring where the oldest objects are overwritten in response to receiving new objects. One or more applications hosted on the communications device 122 may be operative to handle push notification messages and/or pull-based messages by transmitting requests for new messages to one or more remote systems. In some implementations, message activity monitoring application may operate in connection with one or more agents inserted at various layers of one or more communications protocol stacks of the communications device 122. The agents may be operative to monitor for messages corresponding to one to a plurality of different applications (e.g., email, IM, chat, SMS, voice mail, etc.) and pass indications of the messages to the message activity monitoring application. As FIG. 5B illustrates, messages may be expired from the queue after a threshold time period (e.g., 5 minutes, 10 minutes, or any other configurable time period) such that the operational parameters (and, therefore, the state of the message notification indicator) reflect current messaging activity. For example, during periods of high messaging activity of high value, the state of the message indicator may be modulated to present a rapid heartbeat, while during periods of moderate messaging activity the message indicator state may present a relatively moderate heartbeat. In some implementations, activation of the message indicator button 202 launches the client application associated with the messaging having the highest affinity or notification value for the user. In other implementations, the color of the message indicator button 202 can also be modulated to indicate different levels of urgency and/or the number of messages in addition to, or in lieu of, the heartbeat activity.

As FIG. 5A shows, the message activity monitoring application, responsive to receiving an indication of a message (502), may apply decisional logic to the message to decide whether to place the received message on a messaging activity queue (504). For example, the message activity monitoring application may apply one or more rules-based filters to decide whether the message should be added to the messaging activity queue and, thus, potentially influence operating of the message indicator 202 of the communications device 122. The filters may be configured by an application developer as a set of defaults, configured by the end user, and/or generated based on a learning algorithm that learns the types of messages that a user cares most about. The filter rules may be based on a variety of different attributes, such as channel or message type (email, SMS, chat/IM, news feed object, push notification or alert, etc.), source or sender of the message, subject of the message (e.g., whether it involves or relates to the subject user, whether the user has a declared affinity to the subject matter, etc.), meta data associated with the message (added, for example, by a social networking system 100 prior to transmission), a message notification or affinity value appended to the message or computed upon receipt, and the like. For example, the message filter may exclude all news feed objects generally or those not associated with users within a predefined group. If the message passes the filtering operations, the message activity monitoring application adds the message to the messaging activity queue (506). For purposes of clarity, the received message, regardless of whether it is added to the messaging activity queue, is processed by one or more client applications hosted on the communications device 122. For example, if the message is an email message or a news feed object delivered in a push or pull process, an email client or news feed application, as applicable, will also process the received message.

The message activity monitoring application may access the messaging activity queue to compute one or more messaging activity values or metrics based on the messages contained in the queue (508) and adjust one or more notification operating parameters of the message indicator (510). That is, in some implementations, one to a plurality of messages in the messaging activity queue may influence the operational parameters and, thus, the observable behavior of the message indicator 202. Notification operating parameters may include intensity, period (or frequency), color, and duty cycle of the message indicator. In some implementations, the message indicator may operate with a variable frequency and fixed duty cycle, a fixed frequency and variable duty cycle, or a variable frequency and variable duty cycle. The notification operating parameters may be configured and modulated to achieve a variety of different visual indications and behaviors. For example, the message indicator operating parameters and the modulation scheme may be configured to resemble a heartbeat where the frequency and intensity of the visual heartbeat reflects one or more aspects of messaging activity. Color can also be modulated to indicate different types of notifications or messages (e.g., blue for messages, red for missed calls, or to signal varying levels of urgency (e.g., green for low priority and red for high priority). In some implementations, the message indicator button 202 can switch between different colors over a repeating cycle to indicate the types of messages in the message queue.

FIG. 5B illustrates a process that expires messages from the messaging activity queue. As FIG. 5B shows, the message activity monitoring application, on a periodic basis (552), accesses the messaging activity queue to expire old messages (554). Each message may include temporal information (such as a time sent or received). In other implementations, the message activity monitoring application may add a time stamp to the message when it is added to the messaging activity queue. In some implementations, the message activity monitoring application may expire messages older than a threshold period of time. In some implementations, the threshold period of time is the same for all messages. In other implementations, the expiration time can depend on one or more attributes of the message, such as message type, source, subject and the like. In some implementations, messages themselves may include expiration times appended to the message for use by the message activity monitoring application. Social networking system 100 (or any other sender) may configure or append an expiration time to a message sent to the communications device 122. Similar to that illustrated in FIG. 5A, the message activity monitoring application may also access the messaging activity queue to compute one or more cumulative messaging activity values or metrics based on the messages contained in the queue (508) and adjust one or more notification operating parameters of the message indicator (510). By expiring older messages, the operational state of the message indicator 202 reflects current messaging activity. The length of time over which messages expire can vary depending on considerations of engineering, design and user experience. The length of time may also be user configurable.

In some implementations, the messaging activity queue may be assessed across different axes to compute component messaging activity values that individually modulate different respective notification operating parameters. In other implementations, each notification operating parameter may be based on a function that considers two or more component messaging activity values. For example, the message activity monitoring application may consider one to many of the following factors when determining component messaging activity values: 1) the number of messages in the messaging activity queue; 2) the temporal spacing of the messages in the message activity queue; 3) the sources or senders of the messages; 4) the respective subjects of the messages; 5) the respective content of the messages; 6) the context of the message (e.g., whether it was a reply to a previous message sent by the subject user; 7) the message or channel type; 8) social connections between sources of the messages and the subject user (including degrees of separation in a social graph and identified affinities between the sources and the subject user); 9) recency or degree of communication frequency between the sources and the and 8) a notification or affinity value appended to the message. Notification or affinity values may be computed remotely from the communications device 122 (such as at social networking system) and/or locally at the communications device. Computation of notification or affinity values for individual messages is discussed below. The notification operating parameters may be based on one or more functions that depend on the computed notification component values. For example the notification component values may map to a value in a range of operating parameters for intensity, period and/or duty cycle of the message indicator 202.

A variety of implementations are possible. For example, the intensity and/or duty cycle of the notification indicator may signal that a source of a recently received message is a social contact to which the subject user has a high degree of affinity (such as a declared relationship (e.g., girlfriend, boyfriend, etc.) or, based on passed messaging activity, indicates a high degree of affinity). For example, the intensity of the message indicator may vary from a baseline or default level up to a maximum intensity value based on an affinity score between a source of a message and the subject user. In some implementations, the intensity value is based on a single message whose source is associated with the highest affinity value. In other implementations, the intensity value may be based on a cumulative assessment of a plurality of messages. The frequency or period at which a message indicator may flash may signal the number of messages in the message activity queue generally, or the temporal spacing of the messages (or a subset of the messages meeting one or more criterion—e.g., the same sender, topic, etc.). In some implementations, the functions that adjust the operating parameters can be configured such that the operation of the message indicator resembles a heartbeat, where the light intensity reflects an aggregate affinity for messages and the frequency reflects an observed volume or rate of messaging activity. In some implementations, the urgency of one or more messages may be based on time and/or location sensitivity. Messages pushed to a user, for example, that may expire or become moot after a user moves from a given location (and/or after a period of time elapses) may be treated as urgent messages. Location and time sensitivity can be based on analysis of flags or bits set by other processes (such as a sending or relay process) or can be based on semantic analysis at the mobile device.

The following description illustrates an operating environment in which implementations of the invention may operate and discusses how message notification values and affinities between a subject user and a message may be determined. In particular embodiments, the social networking system may store user profile data and social graph information in user profile database 101. The social networking system 100 comprises a number of components used to store information about its users and objects represented in the social networking environment, as well as the relationships among the users and objects. Social networking system 100 may also support one or more messaging applications, such as an instant messaging system, a chat system, a VoIP system, a video chat system, an electronic mail system, a push notification system and the like.

The social networking system 100 additionally comprises components to enable several actions to user devices of the system, as described herein. In particular embodiments, the social networking system may store user event data and calendar data in event database 102. In particular embodiments, the social networking system may store user privacy policy data in privacy policy database 103. In particular embodiments, the social networking system may store geographic and location data in location database 104. In particular embodiments, the social networking system may store media data (e.g., photos, or video clips) in media database 105. In particular embodiments, databases 101, 102, 103, 104, and 105 may be operably connected to the social networking system's front end 120. In particular embodiments, the front end 120 may interact with communications device 122 through network cloud 121. Communications device 122 is generally a computer or computing device including functionality for communicating (e.g., remotely) over a computer network. Communications device 122 may be a desktop computer, laptop computer, personal digital assistant (PDA), in- or out-of-car navigation system, smart phone or other cellular or mobile phone, or mobile gaming device, among other suitable computing devices. Communications device 122 may execute one or more client applications, such as a web browser (e.g., Microsoft Windows Internet Explorer, Mozilla Firefox, Apple Safari, Google Chrome, and Opera, etc.), to access and view content over a computer network. Front end 120 may include web or HTTP server functionality, as well as other functionality, to allow users to access the social networking system. Network cloud 121 generally represents a network or collection of networks (such as the Internet or a corporate intranet, or a combination of both) over which client devices 122 may access the social network system.

In particular embodiments, a user of the social networking system may upload one or more media files to media database 105. For example, a user can upload a photo or a set of photos (often called a photo album), or a video clip to media database 105 from a communications device 122 (e.g., a computer, or a camera phone). In particular embodiments, the one or more media files may contain metadata (often called “tags”) associated with each media file. For example, a photo shot by a digital camera may contain metadata relating to file size, resolution, time stamp, name of the camera maker, and/or location (e.g., GPS) coordinates. A user can add additional metadata values to a photo, or tag a photo, during an upload process. Some examples of tags of a media file are author, title, comments, event names, time, location, names of people appearing in the media file, or user comment. In particular embodiments, a user may tag a media file by using a client application (e.g., a photo or video editor), or entering one or more tags in a graphical user interface of a media uploading tool that uploads a user's one or more media files from a communications device 122 to the social networking system. A user may also tag a media file after an upload at a later time in the social networking system's web site. In particular embodiments, the social networking system may also extract metadata from a media file and store the metadata in media database 105.

In particular embodiments, location database 104 may store geo-location data identifying a real-world geographic location of a user associated with a check-in. For example, a geographic location of an Internet connected computer can be identified by the computer's IP address. For example, a geographic location of a cell phone equipped with Wi-Fi and GPS capabilities can be identified by cell tower triangulation, Wi-Fi positioning, and/or GPS positioning. In particular embodiments, location database 104 may store an information base of places, where each place includes a name, a geographic location and meta information. For example, a place can be a local business, a point of interest (e.g., Union Square in San Francisco, Calif.), a college, a city, or a national park. For example, a geographic location of a place (e.g., a local coffee shop) can be an address, a set of geographic coordinates (latitude and longitude), or a reference to another place (e.g., “the coffee shop next to the train station”). For example, a geographic location of a place with a large area (e.g., Yosemite National Park) can be a shape (e.g., a circle, or a polygon) approximating the boundary of the place and/or a centroid (i.e., geometric center) of the shape. For example, meta information of a place can include information identifying be the user that initially created the place, reviews, ratings, comments, check-in activity data, and the like. Places may be created by administrators of the system and/or created by users of the system. For example, a user may register a new place by accessing a client application to define a place name and provide a geographic location and cause the newly created place to be registered in location database 104. The creating user or other users may access a web page directed to the page and add additional information, such as reviews, comments and ratings for the place. In particular embodiments, location database 104 may store a user's location data. For example, location database 104 may store a user's check-in activities. For example, a user can create a place (e.g., a new restaurant or coffee shop), causing the social networking system to stores the user-created place in location database 104. For example, a user can create a comment, a review, or a rating of a place, causing the social networking system to store the user's comment, review and rating of the place in location database 104.

In particular embodiments, news feed engine 110 may access user profile database 101, event database 102, location database 104 and media database 105 for data about a user or set of users of the social networking system, and assemble a list of one or more activities as news items for a particular user. In particular embodiments, news feed engine 110 may access privacy policy database 103 and determine a subset of news items based on one or more privacy settings. In particular embodiments, news feed engine 110 may compile a dynamic list of a limited number of news items in a ranked or sorted order. In particular embodiments, news feed engine 110 may provide links related to one or more activities in the news items, and links providing opportunities to participate in the activities. For example, a news feed can comprise wall posts, status updates, comments, and recent check-ins to a place (with a link to a web page of the place). In other embodiments, news feed engine 110 may access user profile database 101, event database 102, location database 104 and media database 105 and compile a dynamic list of a limited number of news items about a group of related actions received from users of the social networking system (i.e., a news feed). For example, a news feed can comprise an event that a user may schedule and organize through the social networking system (with a link to participate the event), check-ins at a specific geographical location of the event by the user and other participants of the event, messages about the event posted by the user and other participants of the event, and photos of the event uploaded by the user and other participants of the event.

In particular embodiments, user profile database 101 may store communication channel information and an address book of a user. The address book, in one implementation, may be a superset or a subset of the users of the social networking system that a user has established a friend or contact relationship. A user of communications device 122 may access this address book information using a special purpose or general purpose client application to view contact information. In particular embodiments, the address book may contain one or more contacts (e.g. a person or an business entity), and a name (e.g., first name, and/or last name) and communication channel information for each contact (e.g., a phone number, a user ID for an IM service, an email address, a user ID for a social networking system, home address, etc.). For at least a portion of the address book information, the contact entries may be dynamic in that the contact entry is associated with a user of the social networking system that maintains his or her own account and corresponding user profile with contact information. Accordingly, when a first user changes any aspect of contact information, the revised contact information may be provided to requesting users. In particular embodiments, a user may access the address book, look up and connect to a contact through a communication channel. In some implementations, the communications device 122 may maintain a local copy of the address book that may be refreshed or synchronized at various times.

Message Affinity Scoring

In one embodiment, a process running in a social networking environment requests a measure of affinity for a particular user from a module that implements an affinity function. The module, in one implementation, computes the requested measure of affinity by combining (e.g., adding) a weighted set of predictor functions, where each predictor function predicts whether the user will perform a different action. The weights may be provided by the process that requests the measure of affinity, which allows the requesting process to weight the predictor functions differently. In this sense, the affinity function is tunable by the requesting process for its own purpose. In one implementation, affinities may be computed for the purposes of computing a notification value of a message to an intended recipient.

The predictor functions may predict whether a user will perform a particular action based on the user's interest in the action. For example, a predictor function may be derived based on a user's historical activity (such as interacting with other users utilizing the social networking system functionality discussed above, for example). Additionally, the predictor function may include a decay factor that causes the strength of the signal provided by the user's historical activity to decay with time. The predictor functions may predict any number of actions, which may be within or outside of the social networking system. For example, these actions may include various types of a user's communications, such as messages, posting of content, and commenting on content; various types of a user's observation actions, such as viewing profiles of other connections and viewing photos and content posted by other connections; and various types of coincidence information about two or more users, such as being tagged in the same photograph, checked in at the same location, and attending the same event. A predictor function may be determined using a machine learning algorithms trained on historical activity and past user responses or data farmed from users by exposing them to various options and measuring responses.

To predict the likely actions a user may take in a given situation, any process on the social networking system 100 or outside may request a measure of affinity for a user by providing a set of weights. The measure of affinity may reflect the user's interest in other users, content, actions, advertisements, or any other objects in the social networking system. The weights may be binary or, more generally, any real number. In one implementation, messages intended for a communications device 122 of a subject user that are transmitted or intermediated by the social networking system 100, for example, may be processed to compute an affinity between the subject user and the message. The affinity value can be appended to the message prior to transmission to the communications device 122. In other implementations, a process hosted on the communications device 122 may access the affinity module to request the measure of affinity. In some implementations, the communications device 122 may request affinities between the subject user of the communications device 122 and one or more other users identified in a contacts database of the subject user (stored locally on the communications device 122 or remotely on the social networking system 100). Revised affinity values can be obtained during subsequent synchronization processes. Communications device 122 may use these affinity values for messages from the respective users. In other implementations, the communications device 122 may monitor interactions locally and compute affinity values locally.

FIG. 6 is a block diagram of a function for computing a measure of affinity for users in a social networking system. To compute a measure of affinity 615 that indicates a set of likely actions a user may want to take in any given situation, weights 105 are applied to predictor functions 610 and then combined to obtain a measure of affinity 615. Although FIG. 1 shows three predictor functions 610, any number of predictor functions can be employed in other embodiments of the invention. Additionally, in the embodiment of FIG. 6, the weighted predictor functions 610 are combined linearly. In different embodiments, other forms of combination may be used, including harmonic means, mean squares, and geometric means. Additionally, multiple measures of affinity 615 with varying weights 605 may be computed before predicting a user's actions.

The weights 605 of the affinity function enable it to be used by various processes in the social networking system environment for different purposes. For example, in a process that provides advertisements with social endorsements from a viewer's friends, an ad algorithm may use the measure of affinity 615 function to determine which of a user's connections to mention in the social endorsement or what type of actions to mention in the endorsement. The measure of affinity 615 may then be based on those predictor functions 610 that show how interested the user is in viewing the content posted by another user as well as one or more predictor functions 610 that show how interested the user is in various actions that may be mentioned in the social endorsement. The ad algorithm would thus provide relatively large weights for these predictor functions 610 so that the resulting measure of affinity would more accurately determine which social endorsements would be more interesting to the viewing user. The ad algorithm would then select the social endorsement using the resulting measure of affinity, thereby increasing the likelihood of conversion of the advertisement.

As a second example, in a process for a messaging application that intermediates communications between users, a social algorithm may use the measure of affinity 615 function to determine what level of interest a user may have in a message sent by a particular sending user. The measure of affinity 615 for this purpose may be based on predictor functions 610 that show how interested the user is in viewing the content posted by the user's connections and/or how often the users send messages to one another in general, as well as one or more predictor functions 610 that show how interested the user is posting or accessing different types of messages. Accordingly, the social algorithm would weight these predictor functions 610 relatively high so that the resulting measure of affinity would accurately determine which messages would be more interesting to the viewing user. Because of the highly tunable nature of the affinity function, enabled by the weighted predictor functions 610, it can be used for a number of different purposes.

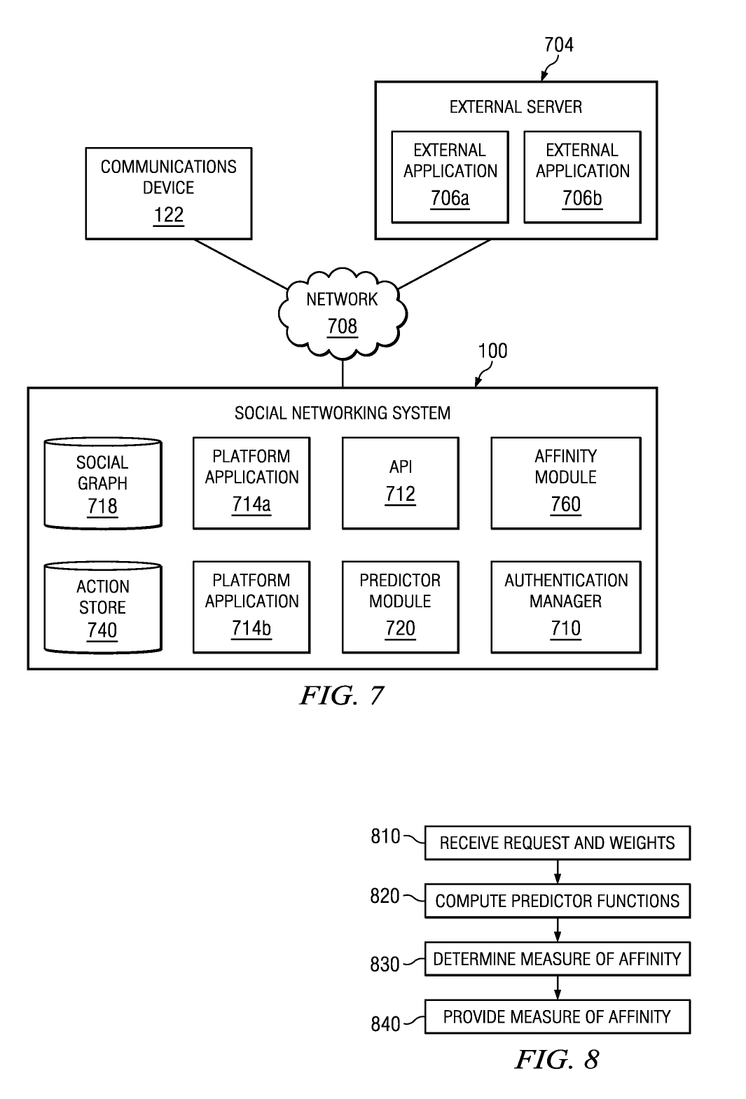

FIG. 7 is a high-level block diagram of an environment of a social networking system, according to one embodiment. FIG. 7 illustrates a social networking system 100, a user device 202, and an external server 704 connected by a network 708. The social graph 718 stores the connections that each user has with other users of the social networking system 100. The social graph 718 may also store second-order connections, in some embodiments. The connections may thus be direct or indirect. For example, if user A is a first-order connection of user B but not of user C, and B is a first-order connection of C, then C is a second-order connection of A on the social graph 718.

The action store 240 stores actions that have been performed by the users of the social networking system 100, along with an indication of the time associated with those actions and references to any objects related to the actions. Additionally, the action store 740 may store statistics for specified categories of actions. For example, for a given user the action store 740 may contain the number of wall posts in 30 days by a user, messages sent by the user, number of photos posted by the user in 30 days and number of distinct users that received the user's comments in 30 days. For a given connection between two users, user A and user B, the action store 740 may contain actions such as the number of profile page views from A to B, the number of photo page views from A to B, the number of messages from A to B, and the number of times A and B were tagged in the same photo, and these actions may be associated with a timestamp or may be filtered by a cutoff (e.g., 24 hours, 90 days, etc.). The actions recorded in the action store 740 may be farmed actions, which are performed by a user in response to the social networking system 100 providing suggested choices of actions to the user.

The predictor module 720 is responsible for computing a set predictor functions 610, which predict whether a user will perform a set of corresponding actions. As discussed above, each predictor function 610 may be representative of a user's interest in a particular action associated with the predictor function 610. The historical activity of a user may be used as a signal of a user's future interest in the same activity. In some embodiments, the predictor function 610 is generated using a machine learned algorithm that is trained using a user's historical activity associated with an action. The predictor module 720 thus provides a predictor function 610 for each of a set of actions, where a predictor function 610 may take as an input the a user's historical activity and then outputs a measure of the likelihood that the user will engage in the corresponding activity.

In some embodiments, one or more of the predictor functions 610 may use a decay factor in which the strength of the signal from a user's historical activity decays with time. Moreover, different predictor functions 610 may decay the historical activity at different rates. For example, some types of user activity, like adding a new connection, indicate a more persistent interest than other types of activity that indicate a more ephemeral interest, like commenting on another user's status. Therefore, the predictor functions 610 may decay the effect of historical activity based on an understanding about how that activity may become less relevant over the passage of time. Various decay mechanisms may be used for this purpose. For example, a predictor function 610 may use a mathematical function, such as an exponential decay, to decay the statistics about a user behavior. In another embodiment, the decay is implemented by selecting only those statistics about a user behavior that occurred within a specific window of time, such as 24 hours or 30 days.

In one embodiment, a predictor function 610 is realized as a ratio of two affine functions as shown in equation (1). The numerator and denominator affine functions take statistics of the user's historical activity as inputs.

$$P = \frac{{a}_{0} + {a}_{1} {x}_{1} + {a}_{2} {x}_{2} + … + {a}_{n} {x}_{n}}{{b}_{0} + {b}_{1} {x}_{n + 1} + … + {b}_{m} {x}_{n + m}} \qquad ( 1 )$$

where

P is the predictor function 610;

aᵢ for i=0, 1, 2, . . . , N are the coefficients in the numerator affine function;

bᵢ for i=0, 1, 2, . . . , M are the coefficients in the denominator affine function; and

xᵢ for i=1, 2, . . . , N+M are the statistics on a user's historical activity related to the predictor function P.

The denominator affine function can represent a normalization of the numerator affine function. For example, the number of comments made by a user may be normalized by, among other statistics, the number of times the user has been active on the social networking system 100. In particular, by altering bᵢ for i=0, 1, 2, . . . , M the normalization pattern can be changed. In some embodiments, some or all of the coefficients, aᵢ for i=0, 1, 2, . . . , N and bᵢ for i=0, 1, 2, . . . , M, are determined through machine learning, which may be implemented by the predictor module 720. In a particular embodiment, a supervised machine learning algorithm is used with the training data obtained through farming, by providing a statistically significant number of users several options and monitoring their response. In another embodiment, the supervised machine learning algorithm is trained entirely based on historical user activity and past responses to choices of actions. The predictor functions 610 may also be non-linear. An example embodiment implements a predictor function 610 for a family where the predictor function 610 includes an ‘if-then’ construct for the members of the family—i.e., the predictor function 610 is computed differently depending on whether it is being computed for the parents or the children.

Some predictor functions 610 in the social networking system 100 may predict actions related to a user's communication in the social networking system 100. The statistics specifically related to communications may include broadcast data and communication data. Broadcast data may include, for example, the number of photos posted by the user in a given time period, the number of posts via applications by the user in a given time period, and any other communication that the user has posted or otherwise distributed to a group of other users. Communication data may include, for example, the number of likes from the user in a given time period, number of comments posted by user in a given time period, and any other information about the user's communication activities.

Similarly, some predictor functions 610 in the social networking system 100 may predict actions related to a user's observation of content in the social networking system 100. The statistics specifically related to observation may include, for example, the number of profile page views by the user of another user in a given time period, the number of photo views by the user in a given time period, the number of views of an advertisement containing a social endorsement in a given time period, and any other activity involving the viewing of content by the user.

Finally, some predictor functions 610 in the social networking system 100 may predict actions related to a user's coincidence with one or more other users of the social networking system. The statistics specifically related to coincidence may include, for example, a rate at which two or more users have been tagged in the same photograph, have checked in at the same location, or have confirmed (e.g., via RSVP) that they will be attending the same event, and any other activity involving an action or object in the social networking system related to multiple users.

The affinity module 760 provides a measure of affinity 615 based on input data about the user from the social networking system 100 using the predictor functions 610. In the embodiment of FIG. 6, the affinity module 760 sums the predictor functions linearly as shown in equation (2). However, other implementations are equally feasible.

A=β₀+β₁P₁+β₂P₂+ . . . +βₛPₛ (2)

where

A is the measure of affinity 615 requested;

Pᵢ for i=0, 1, 2, . . . , s are the s predictor functions 610 in the social networking system 100; and

Bᵢ for i=1, 2, . . . , s are the weights 605 assigned to the s predictor functions 610 in the social networking system 100.

FIG. 8 illustrates an embodiment of a method for computing a measure of affinity 615 for a user based on a request. The social networking system 100 first receives 810 a request from a process for a measure of affinity 615 for a user along with the weights 605 to be assigned to the various predictor functions 610. The request may include the message for which an affinity score is desired or one or more attributes extracted from the message. The social networking system 100 then computes 820 the predictor functions 610 for the user in the predictor module 820. The predictor functions 610 previously computed are combined to determine 830 an overall measure of affinity 615, which is then provided 840 to the requesting process.

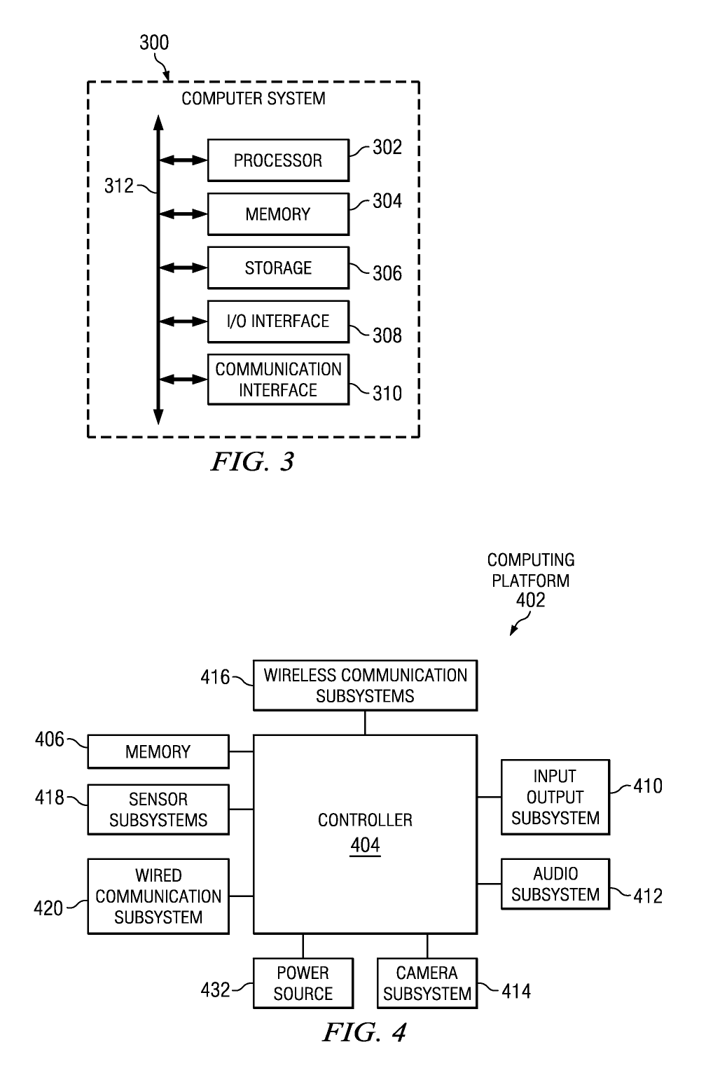

FIG. 3 illustrates an example computer system 300, which may be used with some embodiments of the present invention. For example, the computer system 300 may be used to implement one or more servers of the social networking system that perform the server-side functions described above. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, an interactive kiosk, a mainframe, a mesh of computer systems, a mobile telephone, a personal digital assistant (PDA), a server, or a combination of two or more of these. Where appropriate, computer system 300 may include one or more computer systems 300; be unitary or distributed; span multiple locations; span multiple machines; or reside in a cloud, which may include one or more cloud components in one or more networks. In particular embodiments, computer system 300 includes a processor 302, memory 304, storage 306, an input/output (I/O) interface 308, a communication interface 310, and a bus 312. In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate

In particular embodiments, storage 306 includes mass storage for data or instructions. As an example and not by way of limitation, storage 306 may include an HDD, a floppy disk drive, flash memory, an optical disc, a magneto-optical disc, magnetic tape, or a Universal Serial Bus (USB) drive or a combination of two or more of these. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Although this disclosure describes and illustrates particular storage, this disclosure contemplates any suitable storage.

In particular embodiments, I/O interface 308 includes hardware, software, or both providing one or more interfaces for communication between computer system 300 and one or more I/O devices. Computer system 300 may include one or more of these I/O devices, where appropriate. One or more of these I/O devices may enable communication between a person and computer system 300. In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. In particular embodiments, bus 312 includes hardware, software, or both coupling components of computer system 300 to each other.

The client-side functionality described above can be implemented as a series of instructions stored on a computer-readable storage medium that, when executed, cause a programmable processor to implement the operations described above. While the communications device 122 may be implemented in a variety of different hardware and computing systems, FIG. 4 shows a schematic representation of the main components of an example computing platform of a client or mobile device, according to various particular embodiments. In particular embodiments, computing platform 402 may comprise controller 404, memory 406, and input output subsystem 410. In particular embodiments, controller 404 which may comprise one or more processors and/or one or more microcontrollers configured to execute instructions and to carry out operations associated with a computing platform. In various embodiments, controller 404 may be implemented as a single-chip, multiple chips and/or other electrical components including one or more integrated circuits and printed circuit boards. Controller 404 may optionally contain a cache memory unit for temporary local storage of instructions, data, or computer addresses. By way of example, using instructions retrieved from memory, controller 404 may control the reception and manipulation of input and output data between components of computing platform 402. By way of example, controller 404 may include one or more processors or one or more controllers dedicated for certain processing tasks of computing platform 402, for example, for 2D/3D graphics processing, image processing, or video processing.

Controller 404 together with a suitable operating system may operate to execute instructions in the form of computer code and produce and use data. By way of example and not by way of limitation, the operating system may be Windows-based, Mac-based, or Unix or Linux-based, or Symbian-based, among other suitable operating systems. The operating system, other computer code and/or data may be physically stored within memory 406 that is operatively coupled to controller 404.

Memory 406 may encompass one or more storage media and generally provide a place to store computer code (e.g., software and/or firmware) and data that are used by computing platform 402. By way of example, memory 406 may include various tangible computer-readable storage media including Read-Only Memory (ROM) and/or Random-Access Memory (RAM). As is well known in the art, ROM acts to transfer data and instructions uni-directionally to controller 404, and RAM is used typically to transfer data and instructions in a bi-directional manner. Memory 406 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to controller 404. Information may also reside on one or more removable storage media loaded into or installed in computing platform 402 when needed. By way of example, any of a number of suitable memory cards (e.g., SD cards) may be loaded into computing platform 402 on a temporary or permanent basis.

Input output subsystem 410 may comprise one or more input and output devices operably connected to controller 404. For example, input output subsystem may include keyboard, mouse, one or more buttons, thumb wheel, and/or, display (e.g., liquid crystal display (LCD), light emitting diode (LED), Interferometric modulator display (IMOD), or any other suitable display technology). Generally, input devices are configured to transfer data, commands and responses from the outside world into computing platform 402. The display is generally configured to display a graphical user interface (GUI) that provides an easy to use visual interface between a user of the computing platform 402 and the operating system or application(s) running on the mobile device. Generally, the GUI presents programs, files and operational options with graphical images. During operation, the user may select and activate various graphical images displayed on the display in order to initiate functions and tasks associated therewith. Input output subsystem 410 may also include touch based devices such as touch pad and touch screen. A touchpad is an input device including a surface that detects touch-based inputs of users. Similarly, a touch screen is a display that detects the presence and location of user touch inputs. Input output system 410 may also include dual touch or multi-touch displays or touch pads that can identify the presence, location and movement of more than one touch inputs, such as two or three finger touches.

In particular embodiments, computing platform 402 may additionally comprise audio subsystem 412, camera subsystem 412, wireless communication subsystem 416, sensor subsystems 418, and/or wired communication subsystem 720, operably connected to controller 404 to facilitate various functions of computing platform 402. For example, Audio subsystem 412, including a speaker, a microphone, and a codec module configured to process audio signals, can be utilized to facilitate voice-enabled functions, such as voice recognition, voice replication, digital recording, and telephony functions. For example, camera subsystem 412, including an optical sensor (e.g., a charged coupled device (CCD), or a complementary metal-oxide semiconductor (CMOS) image sensor), can be utilized to facilitate camera functions, such as recording photographs and video clips. For example, wired communication subsystem 720 can include a Universal Serial Bus (USB) port for file transferring, or a Ethernet port for connection to a local area network (LAN).

Wireless communication subsystem 416 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network). Additionally, wireless communication subsystem 416 may include hosting protocols such that computing platform 402 may be configured as a base station for other wireless devices.

Sensor subsystem 418 may include one or more sensor devices to provide additional input and facilitate multiple functionalities of computing platform 402. For example, sensor subsystems 418 may include GPS sensor for location positioning, altimeter for altitude positioning, motion sensor for determining orientation of a mobile device, light sensor for photographing function with camera subsystem 414, temperature sensor for measuring ambient temperature, and/or biometric sensor for security application (e.g., fingerprint reader).

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a MultiMediaCard (MMC) card, an embedded MMC (eMMC) card, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, JavaScript, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising
accessing a message transmitted by a remote host;
identifying an affinity value associated with the message, wherein the affinity value corresponds to a computed social affinity between one or more attributes of the message and a user; and
modulating one or more operating parameters of a message indicator of a communications device based at least in part on the affinity value.

2. The method of claim 1 wherein the one or more operating parameters comprise at least one of intensity, period and duty cycle.

3. The method of claim 1 wherein the one or more operating parameters comprise color.

4. The method of claim 3 further comprising modulating the color of the message indicator based on a type of the message.

5. The method of claim 1 wherein the affinity value for the message is received from the remote host.

6. The method of claim 1 further comprising adding the message to a buffer of messages; and adjusting a cumulative notification value based on the affinity value of the message, wherein the cumulative notification value is operative to control at least one of the one or more operating parameters of the message indicator.

7. A method comprising
accessing a buffer of messages received from one or more respective remote hosts;
determining a cumulative notification value associated with the messages in the buffer; and
modulating one or more operating parameters of a message indicator based on the cumulative notification value.

8. The method of claim 7 wherein the one or more operating parameters comprise at least one of intensity, period and duty cycle.

9. The method of claim 7 wherein the one or more operating parameters comprise color.

10. The method of claim 9 further comprising modulating the color of the message indicator based on a type of at least one of the messages in the buffer.

11. The method of claim 7 wherein the cumulative notification value is based on the number of messages in the buffer and respective affinity values associated with the messages.

12. The method of claim 11 wherein the affinity values are received from a remote host.

13. The method of claim 7 further comprising
expiring older messages from the buffer.

14. An apparatus comprising:
a memory;
one or more network interfaces;
one or more processors;
computer program code stored in a computer readable medium, the computer program code comprising instructions operative to cause the one or more processors to:
access a buffer of messages received from one or more respective remote hosts;
determine a cumulative notification value associated with the messages in the buffer; and
modulate one or more operating parameters of a message indicator based on the cumulative notification value.

15. The apparatus of claim 14 wherein the one or more operating parameters comprise at least one of intensity, period and duty cycle.

16. The apparatus of claim 14 wherein the one or more operating parameters comprise color.

17. The apparatus of claim 16 wherein the computer program code further comprises instructions operative to cause the one or more processors to: modulate the color of the message indicator based on a type of at least one of the messages in the buffer.

18. The apparatus of claim 14 wherein the cumulative notification value is based on the number of messages in the buffer and respective affinity values associated with the messages.

19. The apparatus of claim 18 wherein the affinity values are received from a remote host.

20. The apparatus of claim 14 wherein the computer program code further comprises instructions operative to cause the one or more processors to:
expire older messages from the buffer.
